(19) United States
(12) Patent Application Publication
(10) Pub. No.: US 2016/0371446 A1
(43) Pub. Date: Dec. 22, 2016

(54) METHODS AND SYSTEMS FOR PROVIDING MEDICAL DECISION SUPPORT

(71) Applicant: Yosko, Inc., New York, NY (US)

(72) Inventor: Javier A. Otin, Boston, MA (US)

(21) Appl. No.: 15/186,256

(22) Filed: Jun. 17, 2016

Related U.S. Application Data
(60) Provisional application No. 62/182,135, filed on Jun. 19, 2015.

(51) Int. Cl. G06F 19/00; G06F 17/30

(52) U.S. Cl. CPC G06F 19/345; G06F 19/325; G06F 17/30867; G06F 19/322; G06F 19/3406

(57) ABSTRACT

A medical management environment can include a clinical decision support (CDS) system communicatively coupled to a plurality of client devices associated with medical practitioners, an electronic health record (EHR) database, a content database and/or one or more third-party sources. The CDS system can be configured to communicate with an electronic health record (EHR) database to obtain patients health records. The CDS system can analyze information associated with a patient's health record based on clinical rules and generate a search query for searching data content relevant to the patient's condition(s) in a clinical database or diagnosis database. The CDS system can provide medical content items or diagnosis output received from the clinical database or diagnosis database for display on a client device.

### RELATED APPLICATION

This application claims the benefit under 35 U.S.C. §119(e) of U.S. Provisional Application No. 62/182,135, entitled “METHODS AND SYSTEMS FOR PROVIDING MEDICAL DECISION SUPPORT” and filed Jun. 19, 2015, which is incorporated herein by reference in its entirety.

### FIELD OF THE DISCLOSURE

The present application relates generally to systems and methods for clinical decision support, and more particularly, to methods and systems for providing healthcare providers and practitioners with tools for helping to make comprehensive clinical decisions.

### BACKGROUND

The quality of healthcare services available to a given community or society can significantly impact the life quality of that community or society. Among the factors impacting the quality of healthcare services is the rate of misdiagnosis or delayed diagnosis of medical conditions, illnesses, or injuries. Diagnosis errors can put patients' lives in danger and may result in costly lawsuits for healthcare providers and healthcare practitioners.

### SUMMARY

According to one aspect, a medical management environment can include a clinical decision support (CDS) system communicatively coupled to a plurality of client devices (such as mobile devices associated with medical doctors or other medical practitioners), an electronic health record (EHR) database a content database and/or one or more third-party sources. The CDS system can be configured to communicate with an electronic health record (EHR) database to obtain patients health records. The CDS system can be configured to analyze the information associated with a patient's health record based on clinical rules and generate a search query for searching data content relevant to the patient's condition. The CDS system can send the generated search query to a content database (such as a clinical database) and, in response, corresponding search results indicative of one or more content items can be provided to one or more client devices (such as mobile phone, tablet, laptop, desktop or other client device) associated with one or more medical professionals (such as doctors, nurse practitioners, nurses, etc.) for display.

According to one aspect, a medical management environment can include a clinical decision support (CDS) system communicatively coupled to a plurality of client devices (such as mobile devices associated with medical doctors or other medical practitioners), an electronic health record (EHR) database a content database and/or one or more third-party sources. The CDS system can be configured to communicate with an electronic health record (EHR) database to obtain patients health records. The CDS system can be configured to analyze the information associated with a patient's health record based on clinical rules and generate one or more potential diagnosis scenarios for the patient's conditions. The one or more potential diagnosis scenarios for the patient's conditions can be provided for display on one or more client devices (such as mobile phone, tablet, laptop, desktop or other client device) associated with one or more medical professionals (such as doctors, nurse practitioners, nurses, etc.).

According to one aspect, a system for providing clinical decision support information can include a clinical rule database for storing a plurality of clinical rules. The plurality of clinical rules include at least one clinical rule mapping reference medical test values to one or more medical conditions. The system can also include an analysis module configured to receive, from an electronic health record (HER) database, clinical information associated with a patient. The clinical information can include at least one medical test result. The analysis module can identify one or more clinical rules from the plurality of clinical rules, and analyze the clinical information associated with the patient using the one or more clinical rules to identify one or more keywords indicative of one or more medical conditions of the patient. The analysis module can send a request for clinical decision support information to a data source. The request can include the one or more identified keywords. The analysis module can receive, from the data source responsive to the request for clinical decision support information, one or more content items related to the one or more medical conditions of the patient. The analysis module can provide, via a communications network, the one or more content items for display on a client device.

The system can also include a search module configured to generate a search query using the one or more identified keywords. The request for clinical decision support information can include the search query. The system can also include a medical dictionary database configured to receive a medical acronym from the analysis module, and provide, in response to the receiving medical acronym, a respective full-expression medical term for use by the analysis module to identify the one or more keywords. The analysis module can provide the one or more identified keywords to the client device for review, and receive, from the client device, one or more revised keywords. The request for clinical decision support information can include the one or more revised keywords. The data source can include a diagnosis database and the one or more data items can include a diagnosis content item indicative of one or more diagnosis results.

The system can also include a client application executing on the client device. The client application can cause the client device to receive, from the analysis module, one or more clinical analysis results indicative of the one or more medical conditions of the patient and display, via a user interface (UI) of the client application, the analysis results. The analysis results can include the at least one medical test result of the patient, and the client application can emphasize abnormal medical test result values when displaying the analysis results. The client application can also provide an actionable item for display via the UI. The actionable item allows for initiating the request for the clinical decision support information. The client application can cause the client device, upon actuation of the actionable item by a user of the client device, to send an indication of the actuation of the actionable item, and cause the client device to display, via the UI, the one or more content items received from the analysis module. The client application can also display the one or more identified keywords with the actionable item.

In identifying the one or more keywords, the analysis module can compare a medical test result in the clinical information associated with the patient to a respective reference medical test value range in a clinical rule of the one or more clinical rules. Based on the comparison, the analysis module can identify a medical term indicative of a medical condition mapped to the reference medical test value range as a keyword. The medical term can be extracted from the clinical rule. In some instances, the analysis module can extract a medical acronym from the clinical rule and identify a corresponding medical term by accessing a medical dictionary database.

According to one aspect, a method for providing clinical decision support information can include a computer server receiving, from an electronic health record (HER) database, clinical information associated with a patient. The clinical information can include at least one medical test result. The method can include the computer server identifying one or more clinical rules from a plurality of clinical rules stored in a clinical rule database. The plurality of clinical rules can include at least one clinical rule mapping reference medical test values to one or more medical conditions. The method can include the computer server analyzing the clinical information associated with the patient using the one or more clinical rules to identify one or more keywords indicative of one or more medical conditions of the patient. The method can include the computer server sending a request for clinical decision support information to a data source and receiving, from the data source, one or more content items related to the one or more medical conditions of the patient. The request can include the one or more identified keywords. The method can include the computer server providing, via a communications network, the one or more content items for display on a client device.

The method can also include the computer server generating a search query using the one or more identified keywords. The request for clinical decision support information can include the search query. The method can include the computer server identifying a medical acronym within the clinical information associated with the patient or the one or more clinical rules, and accessing a medical dictionary database to determine a respective full-expression medical term corresponding to the medical acronym. The full-expression medical term can be used by the computer server to identify the one or more keywords. The method can include the computer server providing, via a communications network, the one or more identified keywords to the client device for review, and, in response, receiving, from the client device, and one or more revised keywords. The request for clinical decision support information can include the one or more revised keywords. The data source can include a diagnosis database, and the one or more data items can include a diagnosis content item indicative of one or more diagnosis results.

The method can include the computer server providing, to a client application executing on the client device, one or more clinical analysis results indicative of the one or more medical conditions of the patient, and, in response, the client application displaying, via a respective user interface (UI), the analysis results on the client device. The analysis results can include the at least one medical test result of the patient, and the method can further include the client application emphasizing abnormal medical test result values when displaying the analysis results. The method can include the client application providing an actionable item for display via the UI. The actionable item allows for initiating the request for the clinical decision support information. Responsive to actuation of the actionable item, the client application (or the client device) can send an indication of the actuation of the actionable item to the computer server to initiate search for clinical decision support information. The client application can display, via the respective UI, the one or more content items received from the computer server.

In identifying the one or more keywords, the computer server can compare a medical test result in the clinical information associated with the patient to a respective reference medical test value range in a clinical rule of the one or more clinical rules. Based on the comparison, the computer server can identify a medical term indicative of a medical condition mapped to the reference medical test value range as a keyword. The medical term can be extracted from the clinical rule. In some instances, the computer server can extract a medical acronym from the clinical rule and identify a corresponding medical term by accessing a medical dictionary database.

According to another aspect, a computer-readable medium can include computer code instructions stored thereon, which when executed by a processor of a computing device cause the processor (or the computing device) to receive, from an electronic health record (HER) database, clinical information associated with a patient, the clinical information including at least one medical test result. Execution of the computer code instructions can also cause the processor (or the computing device) to identify one or more clinical rules from a plurality of clinical rules stored in a clinical rule database. The plurality of clinical rules including at least one clinical rule mapping reference medical test values to one or more medical conditions. Execution of the computer code instructions can also cause the processor (or the computing device) to analyze the clinical information associated with the patient using the one or more clinical rules to identify one or more keywords indicative of one or more medical conditions of the patient. Execution of the computer code instructions can also cause the processor (or the computing device) to send a request for clinical decision support information to a data source, and, in response, receive from the data source responsive one or more content items related to the one or more medical conditions of the patient. The request can include the one or more identified keywords. Execution of the computer code instructions can also cause the processor (or the computing device) to provide, via a communications network, the one or more content items for display on a client device.

### BRIEF DESCRIPTION OF THE DRAWINGS

FIG. 1A is a block diagram depicting an embodiment of a network environment comprising local devices in communication with remote devices.

FIGS. 1B-1D are block diagrams depicting embodiments of computers useful in connection with the methods and systems described herein.

FIG. 2 is a block diagram depicting a medical management environment including a clinical decision support (CDS) system for providing clinical decision support to a plurality of client devices.

FIG. 3 shows a sample of clinical rules.

FIG. 4 is a flow diagram illustrating a first method of providing clinical decision support.

FIG. 5A-5C show user interface views of a client application for displaying clinical decision support results on client devices.

FIG. 6 is a flow diagram illustrating a second method of providing clinical decision support.

FIG. 7 shown an example diagnosis output for display on a client device.

### DETAILED DESCRIPTION

For purposes of reading the description of the various embodiments below, the following descriptions of the sections of the specification and their respective contents may be helpful:

Section A describes a network environment and computing environment which may be useful for practicing embodiments described herein.

Section B describes embodiments of systems and methods for clinical decision support.

### A. Computing and Network Environment

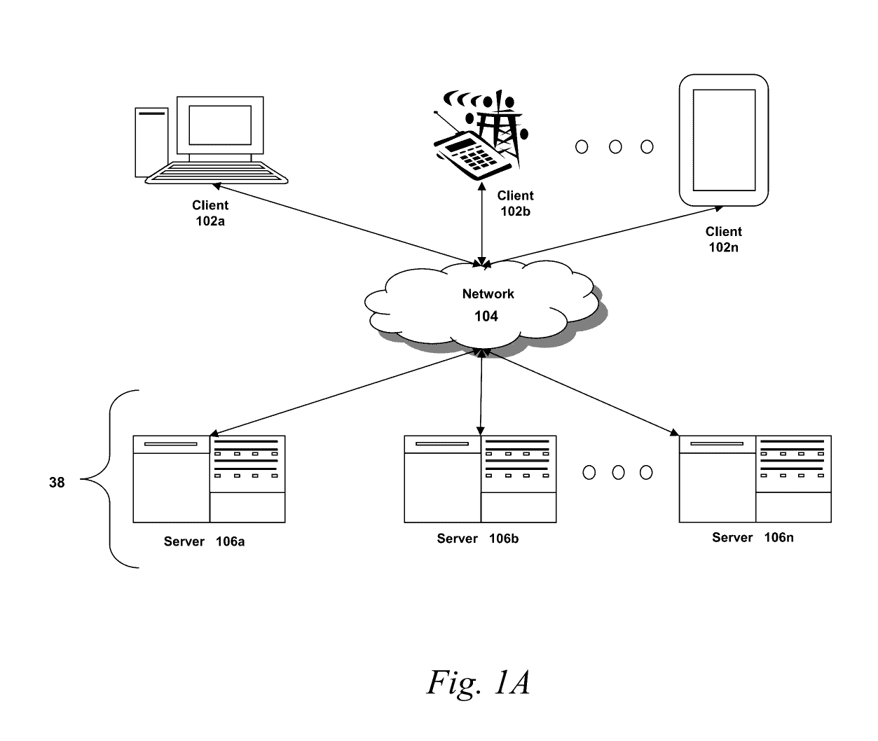

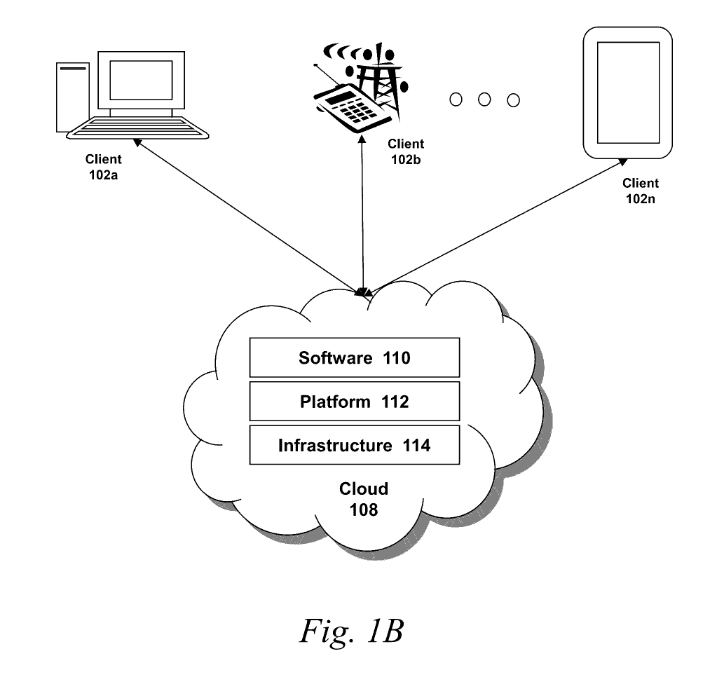

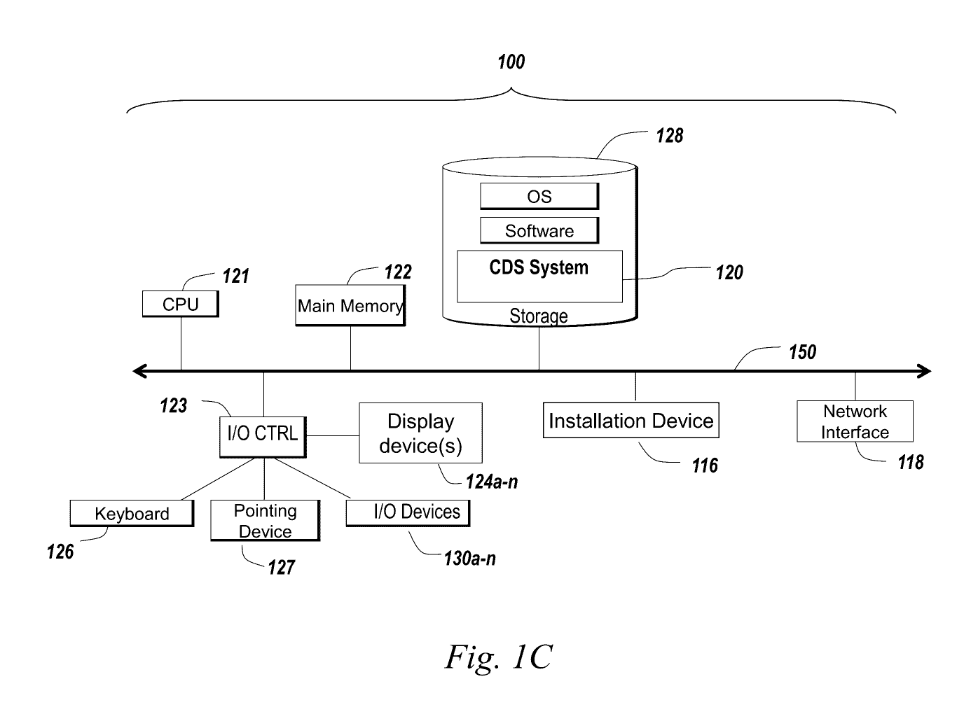

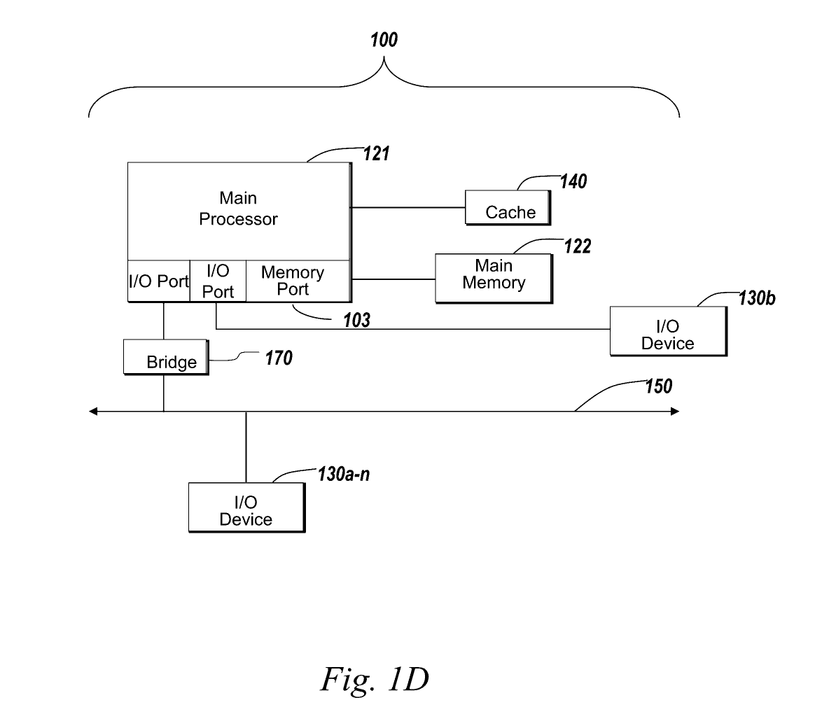

In addition to discussing specific embodiments of the present solution, it may be helpful to describe aspects of the operating environment as well as associated system components (e.g., hardware elements) in connection with the methods and systems described herein. Referring to FIG. 1A, an embodiment of a network environment is depicted. In brief overview, the network environment includes one or more clients 102a-102n (also generally referred to as local machine(s) 102, client(s) 102, client node(s) 102, client machine(s) 102, client computer(s) 102, client device(s) 102, endpoint(s) 102, or endpoint node(s) 102) in communication with one or more servers 106a-106n (also generally referred to as server(s) 106, node 106, or remote machine(s) 106) via one or more networks 104. In some embodiments, a client 102 has the capacity to function as both a client node seeking access to resources provided by a server and as a server providing access to hosted resources for other clients 102a-102n.

Although FIG. 1A shows a network 104 between the clients 102 and the servers 106, the clients 102 and the servers 106 may be on the same network 104. In some embodiments, there are multiple networks 104 between the clients 102 and the servers 106. In one of these embodiments, a network 104′ (not shown) may be a private network and a network 104 may be a public network. In another of these embodiments, a network 104 may be a private network and a network 104′ a public network. In still another of these embodiments, networks 104 and 104′ may both be private networks.

The network 104 may be connected via wired or wireless links. Wired links may include Digital Subscriber Line (DSL), coaxial cable lines, or optical fiber lines. The wireless links may include BLUETOOTH, Wi-Fi, Worldwide Interoperability for Microwave Access (WiMAX), an infrared channel or satellite band. The wireless links may also include any cellular network standards used to communicate among mobile devices, including standards that qualify as 1G, 2G, 3G, or 4G. The network standards may qualify as one or more generation of mobile telecommunication standards by fulfilling a specification or standards such as the specifications maintained by International Telecommunication Union. The 3G standards, for example, may correspond to the International Mobile Telecommunications-2000 (IMT-2000) specification, and the 1G standards may correspond to the International Mobile Telecommunications Advanced (IMT-Advanced) specification. Examples of cellular network standards include AMPS, GSM, GPRS, UMTS, LTE, LTE Advanced, Mobile WiMAX, and WiMAX-Advanced. Cellular network standards may use various channel access methods e.g. FDMA, TDMA, CDMA, or SDMA. In some embodiments, different types of data may be transmitted via different links and standards. In other embodiments, the same types of data may be transmitted via different links and standards.

The network 104 may be any type and/or form of network. The geographical scope of the network 104 may vary widely and the network 104 can be a body area network (BAN), a personal area network (PAN), a local-area network (LAN), e.g. Intranet, a metropolitan area network (MAN), a wide area network (WAN), or the Internet. The topology of the network 104 may be of any form and may include, e.g., any of the following: point-to-point, bus, star, ring, mesh, or tree. The network 104 may be an overlay network which is virtual and sits on top of one or more layers of other networks 104′. The network 104 may be of any such network topology as known to those ordinarily skilled in the art capable of supporting the operations described herein. The network 104 may utilize different techniques and layers or stacks of protocols, including, e.g., the Ethernet protocol, the internet protocol suite (TCP/IP), the ATM (Asynchronous Transfer Mode) technique, the SONET (Synchronous Optical Networking) protocol, or the SDH (Synchronous Digital Hierarchy) protocol. The TCP/IP internet protocol suite may include application layer, transport layer, internet layer (including, e.g., IPv6), or the link layer. The network 104 may be a type of a broadcast network, a telecommunications network, a data communication network, or a computer network.

In some embodiments, the system may include multiple, logically-grouped servers 106. In one of these embodiments, the logical group of servers may be referred to as a server farm 38 or a machine farm 38. In another of these embodiments, the servers 106 may be geographically dispersed. In other embodiments, a machine farm 38 may be administered as a single entity. In still other embodiments, the machine farm 38 includes a plurality of machine farms 38. The servers 106 within each machine farm 38 can be heterogeneous—one or more of the servers 106 or machines 106 can operate according to one type of operating system platform (e.g., WINDOWS NT, manufactured by Microsoft Corp. of Redmond, Wash.), while one or more of the other servers 106 can operate on according to another type of operating system platform (e.g., Unix, Linux, or Mac OS X).

In one embodiment, servers 106 in the machine farm 38 may be stored in high-density rack systems, along with associated storage systems, and located in an enterprise data center. In this embodiment, consolidating the servers 106 in this way may improve system manageability, data security, the physical security of the system, and system performance by locating servers 106 and high performance storage systems on localized high performance networks. Centralizing the servers 106 and storage systems and coupling them with advanced system management tools allows more efficient use of server resources.

The servers 106 of each machine farm 38 do not need to be physically proximate to another server 106 in the same machine farm 38. Thus, the group of servers 106 logically grouped as a machine farm 38 may be interconnected using a wide-area network (WAN) connection or a metropolitan-area network (MAN) connection. For example, a machine farm 38 may include servers 106 physically located in different continents or different regions of a continent, country, state, city, campus, or room. Data transmission speeds between servers 106 in the machine farm 38 can be increased if the servers 106 are connected using a local-area network (LAN) connection or some form of direct connection. Additionally, a heterogeneous machine farm 38 may include one or more servers 106 operating according to a type of operating system, while one or more other servers 106 execute one or more types of hypervisors rather than operating systems. In these embodiments, hypervisors may be used to emulate virtual hardware, partition physical hardware, virtualize physical hardware, and execute virtual machines that provide access to computing environments, allowing multiple operating systems to run concurrently on a host computer. Native hypervisors may run directly on the host computer. Hypervisors may include VMware ESX/ESXi, manufactured by VMWare, Inc., of Palo Alto, Calif.; the Xen hypervisor, an open source product whose development is overseen by Citrix Systems, Inc.; the HYPER-V hypervisors provided by Microsoft or others. Hosted hypervisors may run within an operating system on a second software level. Examples of hosted hypervisors may include VMware Workstation and VIRTUALBOX.

Management of the machine farm 38 may be de-centralized. For example, one or more servers 106 may comprise components, subsystems and modules to support one or more management services for the machine farm 38. In one of these embodiments, one or more servers 106 provide functionality for management of dynamic data, including techniques for handling failover, data replication, and increasing the robustness of the machine farm 38. Each server 106 may communicate with a persistent store and, in some embodiments, with a dynamic store.

Server 106 may be a file server, application server, web server, proxy server, appliance, network appliance, gateway, gateway server, virtualization server, deployment server, SSL VPN server, or firewall. In one embodiment, the server 106 may be referred to as a remote machine or a node. In another embodiment, a plurality of nodes 290 may be in the path between any two communicating servers.

Referring to FIG. 1B, a cloud computing environment is depicted. A cloud computing environment may provide client 102 with one or more resources provided by a network environment. The cloud computing environment may include one or more clients 102a-102n, in communication with the cloud 108 over one or more networks 104. Clients 102 may include, e.g., thick clients, thin clients, and zero clients. A thick client may provide at least some functionality even when disconnected from the cloud 108 or servers 106. A thin client or a zero client may depend on the connection to the cloud 108 or server 106 to provide functionality. A zero client may depend on the cloud 108 or other networks 104 or servers 106 to retrieve operating system data for the client device. The cloud 108 may include back end platforms, e.g., servers 106, storage, server farms or data centers.

The cloud 108 may be public, private, or hybrid. Public clouds may include public servers 106 that are maintained by third parties to the clients 102 or the owners of the clients. The servers 106 may be located off-site in remote geographical locations as disclosed above or otherwise. Public clouds may be connected to the servers 106 over a public network. Private clouds may include private servers 106 that are physically maintained by clients 102 or owners of clients. Private clouds may be connected to the servers 106 over a private network 104. Hybrid clouds 108 may include both the private and public networks 104 and servers 106.

The cloud 108 may also include a cloud based delivery, e.g. Software as a Service (SaaS) 110, Platform as a Service (PaaS) 112, and Infrastructure as a Service (IaaS) 114. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif. PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Clients 102 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP, and may use Representational State Transfer (REST) protocol or Simple Object Access Protocol (SOAP). Clients 102 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 102 may access SaaS resources through the use of web-based user interfaces, provided by a web browser (e.g. GOOGLE CHROME, Microsoft INTERNET EXPLORER, or Mozilla Firefox provided by Mozilla Foundation of Mountain View, Calif.). Clients 102 may also access SaaS resources through smartphone or tablet applications, including, for example, Salesforce Sales Cloud, or Google Drive app. Clients 102 may also access SaaS resources through the client operating system, including, e.g., Windows file system for DROPB OX.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

The client 102 and server 106 may be deployed as and/or executed on any type and form of computing device, e.g. a computer, network device or appliance capable of communicating on any type and form of network and performing the operations described herein. FIGS. 1C and 1D depict block diagrams of a computing device 100 useful for practicing an embodiment of the client 102 or a server 106. As shown in FIGS. 1C and 1D, each computing device 100 includes a central processing unit 121, and a main memory unit 122. As shown in FIG. 1C, a computing device 100 may include a storage device 128, an installation device 116, a network interface 118, an I/O controller 123, display devices 124a-124n, a keyboard 126 and a pointing device 127, e.g. a mouse. The storage device 128 may include, without limitation, an operating system, software, and a software of a clinical decision support (CDS) system 120. As shown in FIG. 1D, each computing device 100 may also include additional optional elements, e.g. a memory port 103, a bridge 170, one or more input/output devices 130a-130n (generally referred to using reference numeral 130), and a cache memory 140 in communication with the central processing unit 121.

The central processing unit 121 is any logic circuitry that responds to and processes instructions fetched from the main memory unit 122. In many embodiments, the central processing unit 121 is provided by a microprocessor unit, e.g.: those manufactured by Intel Corporation of Mountain View, Calif.; those manufactured by Motorola Corporation of Schaumburg, Ill.; the ARM processor and TEGRA system on a chip (SoC) manufactured by Nvidia of Santa Clara, Calif.; the POWER7 processor, those manufactured by International Business Machines of White Plains, N.Y.; or those manufactured by Advanced Micro Devices of Sunnyvale, Calif. The computing device 100 may be based on any of these processors, or any other processor capable of operating as described herein. The central processing unit 121 may utilize instruction level parallelism, thread level parallelism, different levels of cache, and multi-core processors. A multi-core processor may include two or more processing units on a single computing component. Examples of a multi-core processors include the AMD PHENOM IIX2, INTEL CORE i5 and INTEL CORE i7.

Main memory unit 122 may include one or more memory chips capable of storing data and allowing any storage location to be directly accessed by the microprocessor 121. Main memory unit 122 may be volatile and faster than storage 128 memory. Main memory units 122 may be Dynamic random access memory (DRAM) or any variants, including static random access memory (SRAM), Burst SRAM or SynchBurst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM). In some embodiments, the main memory 122 or the storage 128 may be non-volatile; e.g., non-volatile read access memory (NVRAM), flash memory non-volatile static RAM (nvSRAM), Ferroelectric RAM (FeRAM), Magnetoresistive RAM (MRAM), Phase-change memory (PRAM), conductive-bridging RAM (CBRAIVI), Silicon-Oxide-Nitride-Oxide-Silicon (SONOS), Resistive RAM (RRAIVI), Racetrack, Nano-RAM (NRAM), or Millipede memory. The main memory 122 may be based on any of the above described memory chips, or any other available memory chips capable of operating as described herein. In the embodiment shown in FIG. 1C, the processor 121 communicates with main memory 122 via a system bus 150 (described in more detail below). FIG. 1D depicts an embodiment of a computing device 100 in which the processor communicates directly with main memory 122 via a memory port 103. For example, in FIG. 1D the main memory 122 may be DRDRAM.

FIG. 1D depicts an embodiment in which the main processor 121 communicates directly with cache memory 140 via a secondary bus, sometimes referred to as a backside bus. In other embodiments, the main processor 121 communicates with cache memory 140 using the system bus 150. Cache memory 140 typically has a faster response time than main memory 122 and is typically provided by SRAM, BSRAM, or EDRAM. In the embodiment shown in FIG. 1D, the processor 121 communicates with various I/O devices 130 via a local system bus 150. Various buses may be used to connect the central processing unit 121 to any of the I/O devices 130, including a PCI bus, a PCI-X bus, or a PCI-Express bus, or a NuBus. For embodiments in which the I/O device is a video display 124, the processor 121 may use an Advanced Graphics Port (AGP) to communicate with the display 124 or the I/O controller 123 for the display 124. FIG. 1D depicts an embodiment of a computer 100 in which the main processor 121 communicates directly with I/O device 130b or other processors 121′ via HYPERTRANSPORT, RAPIDIO, or INFINIBAND communications technology. FIG. 1D also depicts an embodiment in which local busses and direct communication are mixed: the processor 121 communicates with I/O device 130a using a local interconnect bus while communicating with I/O device 130b directly.

A wide variety of I/O devices 130a-130n may be present in the computing device 100. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers.

Devices 130a-130n may include a combination of multiple input or output devices, including, e.g., Microsoft KINECT, Nintendo Wiimote for the WII, Nintendo WII U GAMEPAD, or Apple IPHONE. Some devices 130a-130n allow gesture recognition inputs through combining some of the inputs and outputs. Some devices 130a-130n provides for facial recognition which may be utilized as an input for different purposes including authentication and other commands. Some devices 130a-130n provides for voice recognition and inputs, including, e.g., Microsoft KINECT, SIRI for IPHONE by Apple, Google Now or Google Voice Search.

Additional devices 130a-130n have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices 130a-130n, display devices 124a-124n or group of devices may be augment reality devices. The I/O devices may be controlled by an I/O controller 123 as shown in FIG. 1C. The I/O controller may control one or more I/O devices, such as, e.g., a keyboard 126 and a pointing device 127, e.g., a mouse or optical pen. Furthermore, an I/O device may also provide storage and/or an installation medium 116 for the computing device 100. In still other embodiments, the computing device 100 may provide USB connections (not shown) to receive handheld USB storage devices. In further embodiments, an I/O device 130 may be a bridge between the system bus 150 and an external communication bus, e.g. a USB bus, a SCSI bus, a FireWire bus, an Ethernet bus, a Gigabit Ethernet bus, a Fibre Channel bus, or a Thunderbolt bus.

In some embodiments, display devices 124a-124n may be connected to I/O controller 123. Display devices may include, e.g., liquid crystal displays (LCD), thin film transistor LCD (TFT-LCD), blue phase LCD, electronic papers (e-ink) displays, flexile displays, light emitting diode displays (LED), digital light processing (DLP) displays, liquid crystal on silicon (LCOS) displays, organic light-emitting diode (OLED) displays, active-matrix organic light-emitting diode (AMOLED) displays, liquid crystal laser displays, time-multiplexed optical shutter (TMOS) displays, or 3D displays. Examples of 3D displays may use, e.g. stereoscopy, polarization filters, active shutters, or autostereoscopy. Display devices 124a-124n may also be a head-mounted display (HMD). In some embodiments, display devices 124a-124n or the corresponding I/O controllers 123 may be controlled through or have hardware support for OPENGL or DIRECTX API or other graphics libraries.

In some embodiments, the computing device 100 may include or connect to multiple display devices 124a-124n, which each may be of the same or different type and/or form. As such, any of the I/O devices 130a-130n and/or the I/O controller 123 may include any type and/or form of suitable hardware, software, or combination of hardware and software to support, enable or provide for the connection and use of multiple display devices 124a-124n by the computing device 100. For example, the computing device 100 may include any type and/or form of video adapter, video card, driver, and/or library to interface, communicate, connect or otherwise use the display devices 124a-124n. In one embodiment, a video adapter may include multiple connectors to interface to multiple display devices 124a-124n. In other embodiments, the computing device 100 may include multiple video adapters, with each video adapter connected to one or more of the display devices 124a-124n. In some embodiments, any portion of the operating system of the computing device 100 may be configured for using multiple displays 124a-124n. In other embodiments, one or more of the display devices 124a-124n may be provided by one or more other computing devices 100a or 100b connected to the computing device 100, via the network 104. In some embodiments software may be designed and constructed to use another computer's display device as a second display device 124a for the computing device 100. For example, in one embodiment, an Apple iPad may connect to a computing device 100 and use the display of the device 100 as an additional display screen that may be used as an extended desktop. One ordinarily skilled in the art will recognize and appreciate the various ways and embodiments that a computing device 100 may be configured to have multiple display devices 124a-124n.

Referring again to FIG. 1C, the computing device 100 may comprise a storage device 128 (e.g. one or more hard disk drives or redundant arrays of independent disks) for storing an operating system or other related software, and for storing application software programs such as any program related to the software for the clinical decision support (CDS) system 120. Examples of storage device 128 include, e.g., hard disk drive (HDD); optical drive including CD drive, DVD drive, or BLU-RAY drive; solid-state drive (SSD); USB flash drive; or any other device suitable for storing data. Some storage devices may include multiple volatile and non-volatile memories, including, e.g., solid state hybrid drives that combine hard disks with solid state cache. Some storage device 128 may be non-volatile, mutable, or read-only. Some storage device 128 may be internal and connect to the computing device 100 via a bus 150. Some storage device 128 may be external and connect to the computing device 100 via a I/O device 130 that provides an external bus. Some storage device 128 may connect to the computing device 100 via the network interface 118 over a network 104, including, e.g., the Remote Disk for MACBOOK AIR by Apple. Some client devices 100 may not require a non-volatile storage device 128 and may be thin clients or zero clients 102. Some storage device 128 may also be used as an installation device 116, and may be suitable for installing software and programs. Additionally, the operating system and the software can be run from a bootable medium, for example, a bootable CD, e.g. KNOPPIX, a bootable CD for GNU/Linux that is available as a GNU/Linux distribution from knoppix.net.

Client device 100 may also install software or application from an application distribution platform. Examples of application distribution platforms include the App Store for iOS provided by Apple, Inc., the Mac App Store provided by Apple, Inc., GOOGLE PLAY for Android OS provided by Google Inc., Chrome Webstore for CHROME OS provided by Google Inc., and Amazon Appstore for Android OS and KINDLE FIRE provided by Amazon.com, Inc. An application distribution platform may facilitate installation of software on a client device 102. An application distribution platform may include a repository of applications on a server 106 or a cloud 108, which the clients 102a-102n may access over a network 104. An application distribution platform may include application developed and provided by various developers. A user of a client device 102 may select, purchase and/or download an application via the application distribution platform.

Furthermore, the computing device 100 may include a network interface 118 to interface to the network 104 through a variety of connections including, but not limited to, standard telephone lines LAN or WAN links (e.g., 802.11, T1, T3, Gigabit Ethernet, Infiniband), broadband connections (e.g., ISDN, Frame Relay, ATM, Gigabit Ethernet, Ethernet-over-SONET, ADSL, VDSL, BPON, GPON, fiber optical including FiOS), wireless connections, or some combination of any or all of the above. Connections can be established using a variety of communication protocols (e.g., TCP/IP, Ethernet, ARCNET, SONET, SDH, Fiber Distributed Data Interface (FDDI), IEEE 802.11a/b/g/n/ac CDMA, GSM, WiMax and direct asynchronous connections). In one embodiment, the computing device 100 communicates with other computing devices 100′ via any type and/or form of gateway or tunneling protocol e.g. Secure Socket Layer (SSL) or Transport Layer Security (TLS), or the Citrix Gateway Protocol manufactured by Citrix Systems, Inc. of Ft. Lauderdale, Fla. The network interface 118 may comprise a built-in network adapter, network interface card, PCMCIA network card, EXPRESSCARD network card, card bus network adapter, wireless network adapter, USB network adapter, modem or any other device suitable for interfacing the computing device 100 to any type of network capable of communication and performing the operations described herein.

A computing device 100 of the sort depicted in FIGS. 1B and 1C may operate under the control of an operating system, which controls scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 2000, WINDOWS Server 2012, WINDOWS CE, WINDOWS Phone, WINDOWS XP, WINDOWS VISTA, and WINDOWS 7, WINDOWS RT, and WINDOWS 8 all of which are manufactured by Microsoft Corporation of Redmond, Wash.; MAC OS and iOS, manufactured by Apple, Inc. of Cupertino, Calif.; and Linux, a freely-available operating system, e.g. Linux Mint distribution (“distro”) or Ubuntu, distributed by Canonical Ltd. of London, United Kingdom; or Unix or other Unix-like derivative operating systems; and Android, designed by Google, of Mountain View, Calif., among others. Some operating systems, including, e.g., the CHROME OS by Google, may be used on zero clients or thin clients, including, e.g., CHROMEBOOKS.

The computer system 100 can be any workstation, telephone, desktop computer, laptop or notebook computer, netbook, ULTRABOOK, tablet, server, handheld computer, mobile telephone, smartphone or other portable telecommunications device, media playing device, a gaming system, mobile computing device, or any other type and/or form of computing, telecommunications or media device that is capable of communication. The computer system 100 has sufficient processor power and memory capacity to perform the operations described herein. In some embodiments, the computing device 100 may have different processors, operating systems, and input devices consistent with the device. The Samsung GALAXY smartphones, e.g., operate under the control of Android operating system developed by Google, Inc. GALAXY smartphones receive input via a touch interface.

In some embodiments, the computing device 100 is a gaming system. For example, the computer system 100 may comprise a PLAYSTATION 3, or PERSONAL PLAYSTATION PORTABLE (PSP), or a PLAYSTATION VITA device manufactured by the Sony Corporation of Tokyo, Japan, a NINTENDO DS, NINTENDO 3DS, NINTENDO WII, or a NINTENDO WIT U device manufactured by Nintendo Co., Ltd., of Kyoto, Japan, an XBOX 360 device manufactured by the Microsoft Corporation of Redmond, Wash.

In some embodiments, the computing device 100 is a digital audio player such as the Apple IPOD, IPOD Touch, and IPOD NANO lines of devices, manufactured by Apple Computer of Cupertino, Calif. Some digital audio players may have other functionality, including, e.g., a gaming system or any functionality made available by an application from a digital application distribution platform. For example, the IPOD Touch may access the Apple App Store. In some embodiments, the computing device 100 is a portable media player or digital audio player supporting file formats including, but not limited to, MP3, WAV, M4A/AAC, WMA Protected AAC, AIFF, Audible audiobook, Apple Lossless audio file formats and .mov, .m4v, and .mp4 MPEG-4 (H.264/MPEG-4 AVC) video file formats.

In some embodiments, the computing device 100 is a tablet e.g. the IPAD line of devices by Apple; GALAXY TAB family of devices by Samsung; or KINDLE FIRE, by Amazon.com, Inc. of Seattle, Wash. In other embodiments, the computing device 100 is a eBook reader, e.g. the KINDLE family of devices by Amazon.com, or NOOK family of devices by Barnes & Noble, Inc. of New York City, N.Y.

In some embodiments, the communications device 102 includes a combination of devices, e.g. a smartphone combined with a digital audio player or portable media player. For example, one of these embodiments is a smartphone, e.g. the IPHONE family of smartphones manufactured by Apple, Inc.; a Samsung GALAXY family of smartphones manufactured by Samsung, Inc.; or a Motorola DROID family of smartphones. In yet another embodiment, the communications device 102 is a laptop or desktop computer equipped with a web browser and a microphone and speaker system, e.g. a telephony headset. In these embodiments, the communications devices 102 are web-enabled and can receive and initiate phone calls. In some embodiments, a laptop or desktop computer is also equipped with a webcam or other video capture device that enables video chat and video call.

In some embodiments, the status of one or more machines 102, 106 in the network 104 is monitored, generally as part of network management. In one of these embodiments, the status of a machine may include an identification of load information (e.g., the number of processes on the machine, CPU and memory utilization), of port information (e.g., the number of available communication ports and the port addresses), or of session status (e.g., the duration and type of processes, and whether a process is active or idle). In another of these embodiments, this information may be identified by a plurality of metrics, and the plurality of metrics can be applied at least in part towards decisions in load distribution, network traffic management, and network failure recovery as well as any aspects of operations of the present solution described herein. Aspects of the operating environments and components described above will become apparent in the context of the systems and methods disclosed herein.

### B. Systems and Methods for Providing Clinical Decision Support

The present disclosure relates to systems and methods for providing clinical decision support information. According to one aspect, a medical management environment can include a clinical decision support (CDS) system communicatively coupled to a plurality of client devices (such as mobile devices associated with medical doctors or other medical practitioners) and a plurality of medical and health data sources. The CDS system can be configured to communicate with an electronic health record (EHR) database to obtain patients health records. In some implementations, the CDS system can analyze the information associated with a patient's health record based on clinical rules to generate a search query for searching data content relevant to the patient's condition. The CDS system can send the generated search query to a content database (such as a clinical database) and, in response, receive corresponding search results including indications (such as title, hyperlink, summary, thumbnail image or a combination thereof) of one or more content items. The CDS system can send the received search results to one or more client devices (such as mobile phone, tablet, laptop, desktop or other client device) associated with one or more medical professionals (such as doctors). In some implementations, the CDS system can analyze the information associated with a patient's health record to generate one or more potential diagnoses for the patient's conditions. The CDS system can send the generated diagnoses to one or more client devices (such as mobile phone, tablet, laptop, desktop or other client device) associated with one or more medical professionals (such as doctors, nurse practitioners, nurses, etc.).

The medical management environment can help medical care providers, such as doctors, provide more comprehensive diagnoses and treatments to respective patients. The medical management environment can also help reduce misdiagnosis or delayed diagnosis rates, reduce medical malpractice law suits, increase medical staff efficiency and increase medical service providers profitability. When diagnosing patients, medical professionals can overlook some important medical information or can fail to deduce the correct diagnosis based on medical test results. For example, some abnormal medical results by be indicative of more than one disease and a medical professional may omit to consider one or more of such diseases. The medical management environment can provide a comprehensive list of diagnosis options to be considered when making a diagnosis decision. The medical professional can eliminate some of the diagnosis options provided by the medical management environment, for example, by performing additional medical exams or medical tests. The medical management environment can also provide information regarding relevant medications and respective side effects allowing the medical professional to prescribe the “proper” medication given a patient's medical conditions.

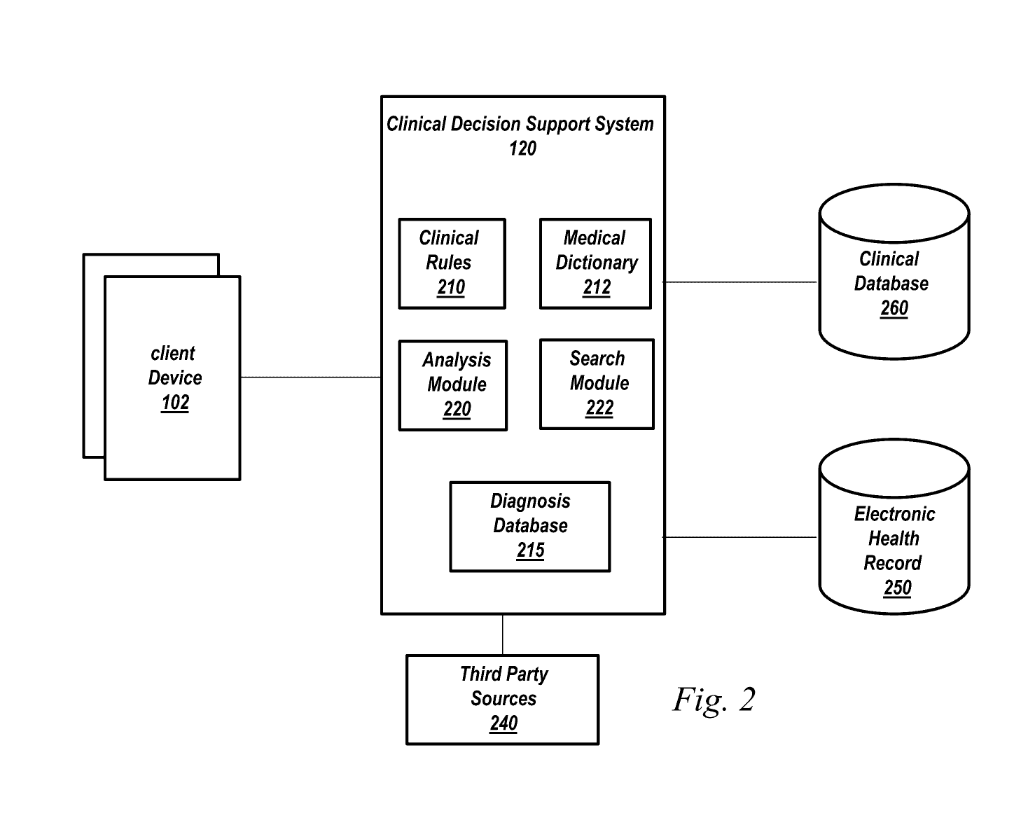

FIG. 2 is a block diagram depicting a medical management environment including a clinical decision support (CDS) system 120 for providing clinical decision support to a plurality of client devices 102. The CDS system 120 can be implemented in one or more computing devices, such as computer servers, desktops, or laptops. The CDS system 120 can communicate with the client devices 102, via one or more communications networks. Similarly, the CDS system 120 can also communicate with an electronic health record (EHR) database 250 and/or a clinical database 260 via one or more communications networks. The CDS system 120 can include one or more clinical rules databases 210, a diagnosis database 215, one or more medical dictionary databases 212, an analysis module 220 and a search module 222. The CDS system 120 can also communicate with one or more third-party data sources 240, for example, databases (or web pages) associated with medical research journals, health and nutrition databases (or web pages), pharmaceutical drug databases, pharmacy databases, a department of health database (or website), Food and Drug Agency (FDA) database (or website), among others.

The electronic health record (EHR) database 250 can be a database storing patients health and medical information. The EHR database 250 can be configured to maintain a health record for each patient. A patient's health record can include information such as a patient profile, clinical information, medications, allergies, vital signs and medical tests. A patient's profile can include information indicative of the name, age (or date of birth) gender, marital status, ethnicity (or race), or occupation of the patient. The patient's clinical information can include indications of present and previous medical conditions of the patient and previous diagnoses. The clinical information can include indications of previous patient's visits to a doctor's office or a medical facility (such as indications of date, location and/or medical doctor or practitioner for each visit), patient's reasons for the visits (such as patient's complaints), and the diagnosis made at each visit. The clinical information can also include patient's complaints (such as a patient's inquiry performed by a nurse or other medical practitioner) with respect to a current visit. The medications information can include a list of medications currently consumed by the patient, a list of medications previously consumed by the patient or a combination thereof. In some implementations, the medication information can further include indications of any medical devices used by the patient. The allergies information can include a list of allergies (such as drug allergies, that the patient is suffering from. The vital signs information can include vital signs measurements taken during a current visit and/or measurements taken during previous visits of the patient to a doctor's office or a medical facility. The vital signs information can include indications of the date, location and measurement values associated with each set of vital signs measurements (such as body temperature, heart rate, pulse rate, blood pressure, respiratory rate and/or oxygen level in blood). In some implementations, the vital signs information can further include patient's weight measurements. The medical tests information can include indications of medical tests (such as blood tests, urine test, biopsies, medical imaging tests, mental health tests, hearing tests, visual tests, or any other medical tests) performed on the patient, the respective dates, the entities that requested the tests, the entities that performed the tests, the test results (or test status) or a combination thereof.

The EHR database 250 can be configured to be searchable using an identification of a patient such as a patient's name or a patient's identification number (or code). For example, the EHR database 250 can receive a request including a patient identifier (ID) from the CDS system 120 or from a client device 102, and, in response, provide information (such as profile information, clinical information, or medical history information) of the patient associated with the ID in the request. In some implementations, the EHR database 250 can be configured to provide statistical data. For instance, the EHR database 250 can also be configured to provide statistical data in response to a query using one or more patient's attributes (such us an age group, gender group, ethnicity group, specific health condition, specific medication or a combination thereof). In such instance, the EHR database 250 can provide statistical data of patients sharing the attributes in the query. For example, the statistical data can include statistics of a disease or a medical condition among a population group defined by age, gender, ethnicity, a medical history attribute, or a combination thereof.

The clinical database 260 can include information indicative of news, studies and research results associated with the medical field, the field of nutrition and wellbeing, pharmaceutical and drugs field, biotechnology field or a combination thereof. For example, the clinical database 260 can include research articles, study and survey results, health related news, announcements, alerts or publications by the health department or healthcare institutions, announcements or publications by pharmaceutical companies, or a combination thereof. Content provided by the clinical database 260 can be related to a given disease or health condition, specific drug, health threat (such as spreading infectious disease or bacterial infection), health conditions associated with a given population group, health or medical blogs, new research breakthroughs in the medical, biotechnology or pharmaceutical fields, or a combination thereof. In general, the clinical database 260 can be configured to maintain and provide access to health related information that can help medical doctors and other medical practitioners provide a more comprehensive healthcare service or can help educate patients about their wellbeing, health conditions and/or treatments.

In some implementations, the clinical database 260 can be a database provided by a third party. In some implementations, the clinical database 260 can be a website available on the Internet. In some implementations, the clinical database 260 can be a web service configured to receive a search query, use the search query to search a plurality of webpages or data resources, and provide the obtained results to the CDS system 120. The clinical database 260 can be configured to receive a search query from the CDS system 120 or the search module 222 thereof and, in response, provide corresponding search results. The search results can include hyperlinks, textual data, image data, video data, or a combination thereof. In some implementations, the clinical database 260 can be configured to rank, order and/or filter content items determined in a search responsive to a search query. The ranking, ordering and/or filtering of the search results can be based on one or more criteria such as relevance of content items with respect to keywords in the search query, rating of the content items by users, the credibility or authenticity of respective sources, or other criteria.

The third-party sources 240 can include data sources (such as websites or databases) associated with pharmaceutical companies, pharmacies, medical labs, medical schools, medical journals, hospitals, medical device companies, or a combination thereof. The CDS system 120 can be configured to access the third-party sources to obtain information for use to update the clinical rules database(s) 210 and/or the medical dictionary database(s) 212 or information for use by the analysis module 220. For instance, the CDS system 120 can access a data source (such as a webpage or database) associated with a pharmacy or pharmaceutical company to search for information related to a specific drug (such as side effects or alternative drugs). The CDS system 120 can also access a data source (such as a webpage or database) associated with a medical lab to obtain a comprehensive description of a lab test and respective results.

The clinical rules database(s) 210 can include one or more data structures (such as tables, text documents, trees, linked lists, or a combination thereof) storing information indicative of a plurality of clinical rules. The clinical rules can be indicative of abnormalities or medical conditions associated with lab tests (such as blood tests, urine tests, biopsies, etc.), vital signs (such as body temperature, pulse or heart rate, blood pressure, etc.) or other measurements (such as weight and height, visual acuity measurements, audiometric tests, mental health assessment tests, speech and language assessment tests, etc.) that can help assess the physical health of a person. For instance, a clinical rule can be indicative of abnormal (and/or normal) value range(s) or value(s) associated with a respective clinical test or health assessment measurement, one or more medical conditions (or symptoms) associated with the abnormal range(s) or value(s), or a combination thereof. For example, a medical rule can map reference medical test values (or value ranges) to related medical conditions. In some implementations, a clinical rule can depend on the age, gender, ethnicity or other attributes of a patient. For instance, the heart rate of a baby is much faster than that of an adult and accordingly abnormal (or normal) heart rate range(s) or value(s) can vary based on age. The clinical rules database(s) 210 can be maintained by the CDS system 120. In some implementations, the CDS system 120 can be configured to update the clinical rules database(s) 210, for instance, to add a new clinical rule, delete an existing rule or modify a clinical rule based on new medical research results or other changes in the medical field. In some implementations, the clinical rules database(s) 210 can be maintained by a third-party system accessible by the CDS system 120.

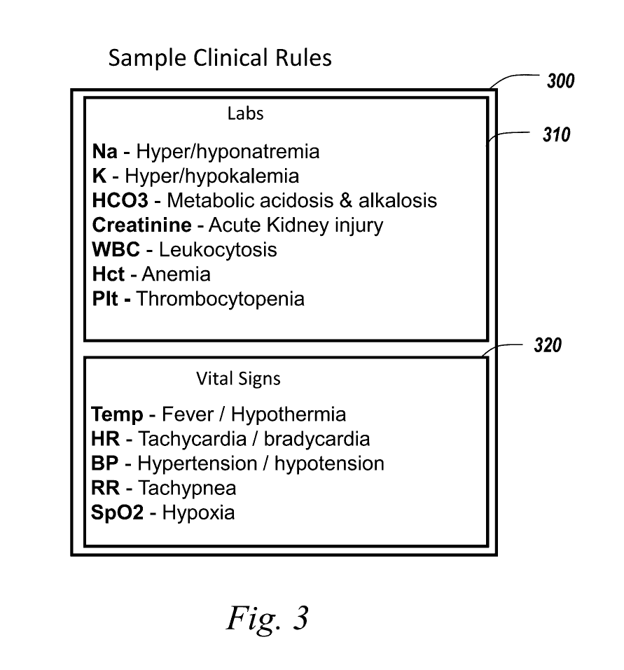

FIG. 3 shows a sample 300 of clinical rules. The sample 300 includes a first set of clinical rules 310 associated with a plurality of blood tests and a second set of clinical rules 320 associated with vital signs. The first clinical rule in the first set 310 is associated with serum sodium concentration in the blood and is indicative of two respective medical conditions hyponatremia and hypernatremia. While not shown in FIG. 3, the first clinical rule can map a first serum sodium concentration range to hyponatremia, and map a second serum sodium concentration range to hypernatremia. For instance, a serum sodium concentration less than 135 mEq/L is indicative of hyponatremia (i.e., an excess of body water relative to body sodium) and a serum sodium concentration exceeding 145 mEq/L is indicative of hypernatremia (i.e., reduced body water relative to body sodium). The first clinical rule in the second set 320 is associated with body temperature and is indicative of fever or hypothermia (i.e., a medical condition of having an abnormally low body temperature). This clinical rule can map a first body temperature value range to fever, and map a second body temperature value range to hypothermia. In some implementations, multiple clinical rules can be associated with a single test or measurement. For instance, with respect to body temperature, the clinical rules database(s) 210 can include another clinical rule, in addition to the first clinical rule in the second set 320, indicative of fever in case of a body temperature higher than normal. A clinical rule can also map one or more symptoms (such as pain, headache, sleep disorder, eye redness, or skin discoloration) to a respective medical condition. Also, a clinical rule can be configured to map multiple reference test results' values or symptoms to a one or more medical conditions.

The medical dictionary database(s) 212 can include one or more lists of medical, biotech, pharmaceutical and healthcare acronyms and abbreviations. The acronyms or abbreviations can be mapped to corresponding full-expression scientific (such as medical, biotech, pharmaceutical or healthcare) terms. The medical dictionary database(s) 212 can also include one or more lists of medical terms and their corresponding definitions. The medical dictionary database(s) 212 can be configured to receive an acronym or abbreviation and provide the corresponding full-expression scientific term(s). In some implementations, the medical dictionary database(s) 212 can provide the full-expression scientific term(s) and the corresponding definition(s) in response to a received acronym or abbreviation. The medical dictionary database(s) 212 can be configured to receive an indication of a scientific term and provide the corresponding definition(s). The medical dictionary database(s) 212 can be maintained by the CDS system 120 as shown in FIG. 2. In some implementations, the CDS system 120 can be configured to update information (for instance, by adding new terms or acronyms, deleting existing terms or acronyms or modifying information associated with a term or acronym) stored in the medical dictionary database(s) 212 based on information received (or retrieved) from the third-party sources 240, the clinical database 260, the electronic health record 250 or a combination thereof. While FIG. 2 shows the medical dictionary database(s) 212 as being a component of the CDS system 120, in some implementations, the medical dictionary database(s) 212 can be third-party source 240 accessible by the CDS system 120.

The search module 222 can be a software module configured to format search queries for sending to the clinical database 260, the EHR database 250, the third-party sources 240 or a combination thereof. For example, the search module 222 can eliminate repetitions among keywords within a search query. The search module 222 can be configured to introduce grammatical conjunctions (such as “or” or “and”) or punctuation marks in a search query to improve corresponding search results. In some implementations, the search module 222 can be configured to format search queries for sending to a given data source (such as a database or web page) in accordance with formatting rules or guidelines specific to that data source.

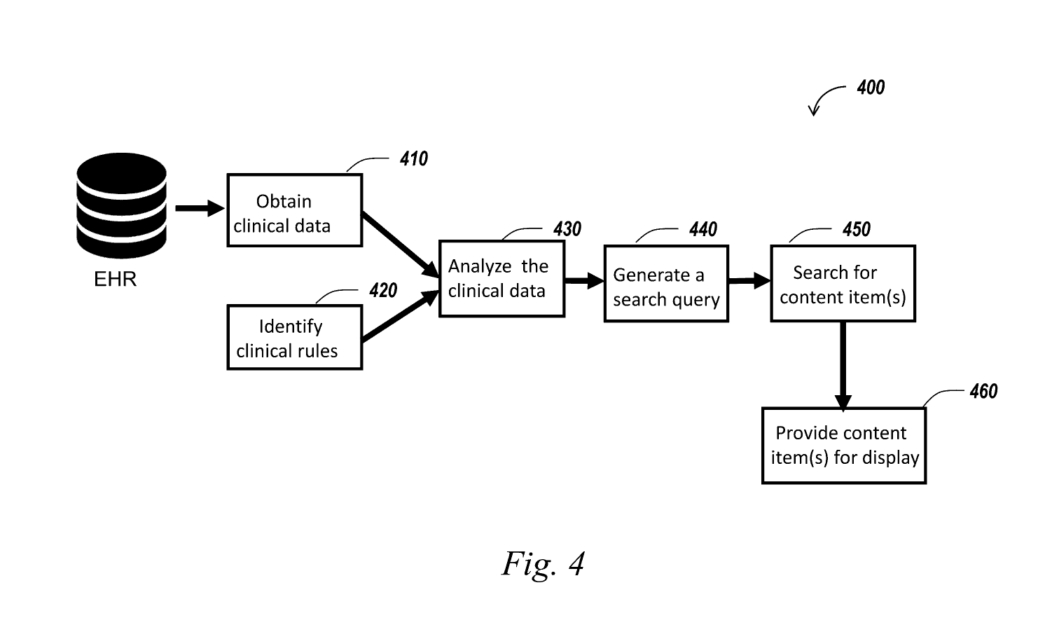

The analysis module 220 can be configured to analyze a patient's clinical information to generate or obtain respective clinical decision support information. The clinical decision support information can include published content relevant to patient medical condition(s) or potential diagnoses of the patient's condition(s). The analysis module 220 can be implemented as a processing engine (or software module) which when executed by one or more processors can provide clinical decision support information. More detailed description of the functions that can be carried out by the analysis module 220 is provided below with regard to FIGS. 4-7.

FIG. 4 is a flow diagram illustrating a first method 400 of providing clinical decision support information. The method 400 can include obtaining (or retrieving) clinical information for a patient from the EHR database 250 (stage 410), identifying one or more clinical rules from the clinical rules database(s) 210 (stage 420), analyzing the patient clinical information based on the one or more identified clinical rules (stage 430), generating a search query (stage 440), identifying one or more content items from an external content data source (stage 450), and providing the one or more content items to a client device 102 for display (stage 460).

In some implementations, the method 400 can be triggered in response to a request from a client device 102 (such as a mobile phone, tablet, laptop, desktop or other client device) associated with a healthcare provider or a medical professional. For instance, a nurse or a medical assistant can generate such a request through a respective client device 102 upon entering vital signs measurements, questionnaire results (such as complaints by the patient upon visiting a medical facility or a doctor's office), or medical test results into the EHR database 250. A doctor can also generate the request, for instance, after examining the patient. The request can include an identification of the patient. The request can include a patient ID. In some implementations, the method 400 can be triggered in response to a notification sent from the EHR database 250 indicative of a recent change to the health record of a given patient. The notification can include an identification of the patient.

The method 400 can include the analysis module 220 obtaining (or receiving) clinical data of the patient from the EHR database 250 (stage 410). In some implementations, the analysis module 220 can send a request (including a patient ID) for the whole medical record of the patient or a portion thereof. For instance, with regard to medical test results, the analysis module 220 can retrieve only most recent test results or test results associated with a specific time period. With regard to previous diagnoses and medical conditions, the analysis module 220 can be configured to receive only diagnoses associated with chronical diseases or medical conditions, recurrent medical conditions or diseases, serious medical conditions or diseases, or a combination thereof. In some implementations, the medical professional requesting the clinical decision support information can specify (such as through a date range, or one or more keywords) the patient medical information to be considered. In some implementations, the analysis module 220 can obtain the complete medical record of the patient and then extract (or filter) relevant information based on one or more criteria such as a date range, one or medical conditions, types of medical data, or a combination thereof.

The analysis module 220 can identify (or obtain) one or more clinical rules from the clinical rules database(s) 210 (stage 420). In some implementations, the analysis module 220 can determine the one or more clinical rules based on the obtained patient clinical data. In some implementations, the analysis module 220 can send one or more keywords and the clinical rules database(s) 210 can respond back with clinical rules relevant to the received keywords. The keywords can be indicative of lab tests or results thereof, vital signs or results thereof, other clinical tests or results thereof, symptoms conveyed by patient or determined through medical examination (such as pain, headache, skin discoloration, organ swelling, eye redness, or sleep disorder), or a combinations thereof. The keywords can also be indicative of medical history of the patient, such as chronic diseases the patient was previously diagnosed for, surgeries previously performed on the patient, congenital anomalies, or genetic disorders. The analysis module can extract the keywords from the patient clinical data received from the EHR database 250 or from a client device 102. The clinical rules database(s) 210 can search for (or identify) clinical rules based on the keywords received from the analysis module 220, and provide the identified clinical rules to the analysis module 220.

The analysis module 220 can then analyze the patient clinical data based on the obtained clinical rules (stage 430). The analysis module 220 can use the clinical rules to determine abnormalities in vital signs measurements, lab test results or other medical test results. The analysis module 220 can identify one or more medical conditions by comparing medical test results from the patient clinical data to reference medical test results in the clinical rules obtained from the clinical rules database(s) 210. For instance, the analysis module 220 can identify a hypertension condition by comparing blood pressure measurements provided in the patient clinical data to reference blood pressure values in a clinical rule associated with blood pressure values (such as the third clinical rule in the clinical rule set 320 shown in FIG. 3). The analysis module 220 can also identify a diabetic condition by comparing measured blood sugar level indicated in the patient clinical data to a clinical rule related to diabetes. For symptoms indicated in the patient clinical data, the analysis module 220 can determine clinical rules (e.g., among the clinical rules received from the clinical rules database 210) which include indication(s) of a symptom and identify the medical condition(s) mapped to the symptom in the determined clinical rule(s).

The analysis module 220 can then use the identified medical conditions or abnormalities in combination with patient clinical (or medical) data to determine medical and health fields (or subject matter) that may be relevant to the patient medical condition(s). For instance, besides the identified medical conditions or abnormalities identified based on the clinical rules, the analysis module 220 can also use medications currently consumed by the patient, patient chronical diseases, patient allergies, or other patient medical information to determine medical and health information that may help the medical professional(s) perform a comprehensive and accurate diagnosis and provide the right treatment for the patient. For instance, medications currently consumed by the patient can be relevant with regard to respective side effects when used alone or in combination with other medications that may be prescribed to the patient. Also, information related to existing chronical diseases or medical conditions can help the medical professional (such as a doctor) resolve any potential correlation between current symptoms of the patient and such exiting diseases or medical conditions. Patient demographic information (such as age, gender, pregnancy for women, ethnicity) can help identify or anticipate health issues that may be specific to given demographics.

The analysis module 220 can generate one or more keywords in response to analyzing the patient clinical data using clinical rules (stage 440). The analysis module 220 can also use clinical data elements (from example from the patient clinical or medical data) that are determined to be of relevance to the patient health in generating (or identifying) the one or more keywords. For example, the analysis module 220 can identify terms in one or more clinical rules indicative of relevant medical conditions as keywords. The analysis module can also identify terms (from the patient clinical or medical data) indicative of patient's medical history or indicative of medication consumed by the patient as keywords. The analysis module can also generate keywords based on the patient's profile, such as indication of gender, age, ethnicity, recent visits to foreign countries, or a combination thereof. The analysis module can provide the identified keywords to the search module 222 to generate a corresponding dynamic search query. The search module 222 can format a search query in real time (e.g., immediately triggered by receipt of the patient clinical data and the clinical rules) using the identified keywords and one or more query formatting rules.

In processing the patient clinical data and clinical rules or when generating the keywords, the analysis module 220 can be configured to access the medical dictionary database(s) 212 to translate acronyms or abbreviations into more meaningful and comprehensible medical terminology. The keywords, can be related to identified abnormalities, existing medical conditions (or diseases), medication, demographic group(s) or other medical or health attributes associated with the patient. As described above with respect the FIG. 2, the search module 222 can be configured to format the dynamic search query according to a give format, guidelines or formatting rules. In some implementations, the search module 222 can be optional. In such implementations, either the analysis module 220 can be configured to perform formatting of the dynamic search query or no formatting is applied to the generated keywords.

In some implementations, the CDS system 120 can send the dynamic search query (or keywords thereof) to a client device 102 for potential editing by a corresponding user (such as a doctor). For instance, the user can add more keywords, delete one or more keywords, or approve the keywords identified by the CDS system 120. The dynamic keywords The client device 102 can send, to the CDS system 120, an indication of initiating a search of clinical decision support information based on the edited or approved keywords.

The CDS system 120 can initiate a search for relevant medical content items in one or more data sources based on the generated dynamic search query or the identified keywords (stage 450). The CDS system 120 can send the dynamic search query to one or more external data sources (such as the clinical database 260 or third-party sources 240) to request content items relevant to the dynamic search query. The external data source(s) can search content items based on the dynamic search query and provide corresponding search results (such as the identified content items or indications thereof) to the CDS system 120 or the client device. In some implementations, the dynamic search query or the identified keywords can be sent directly from the client device 102 to the external data sources.

Upon receiving the search results from the external data sources, the CDS system 120 or a module thereof (such as the analysis module 220) can provide the search result(s) for display on one or more client devices 102 associated with a medical professional such as a doctor (stage 460). In some implementations, the CDS system 120 can send the search results as a hyperlink in a text message. In some implementations, the CDS system 120 can incorporate the search results within a patient folder or patient data record (such as a data record associated with a client application) accessible by client devices 102 of the medical professional. In some implementations, the CDS system 120 can store the search results in a server accessible via a client application executing on the client devices 102. The CDS system 102 can send the search results to a client device 102 responsive to a request received from that client device 102.

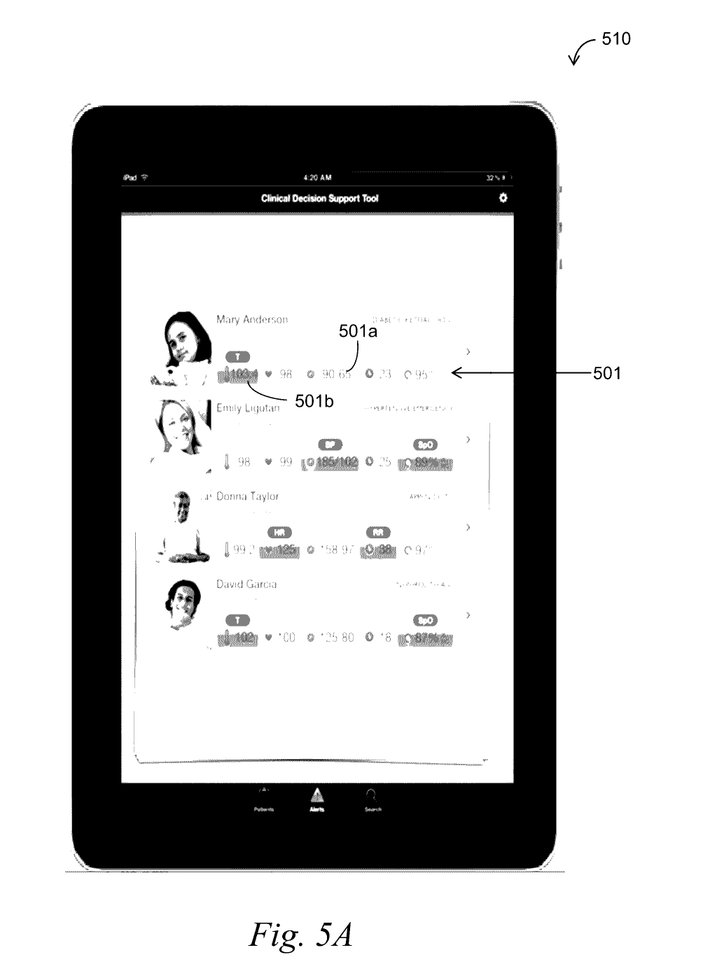

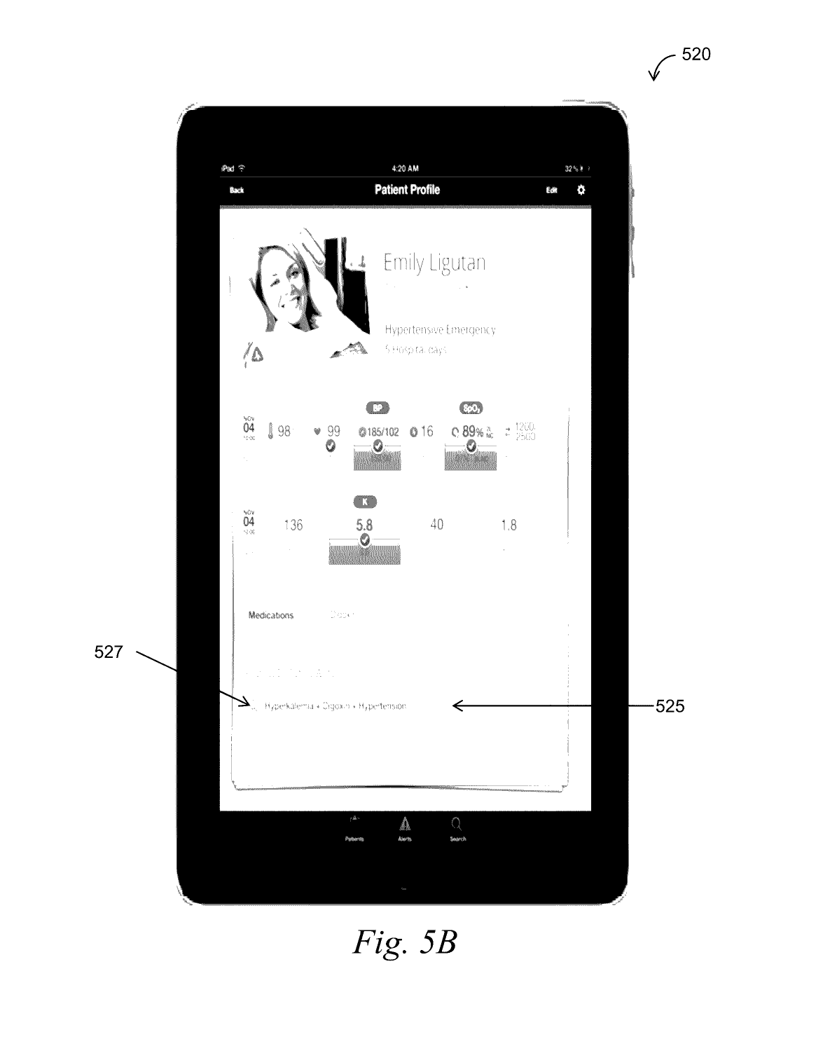

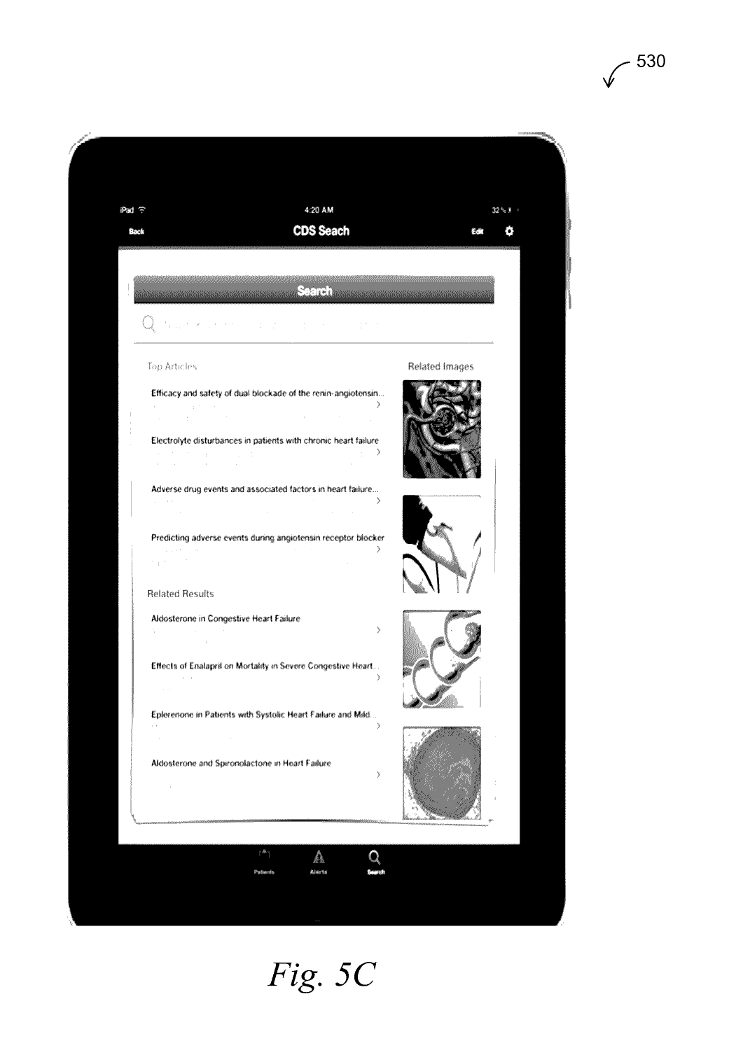

FIGS. 5A-5C shows user interface views associated with a client application for displaying patient medical information and clinical decision support results on client devices 102. The client application when installed on a client device 102 allows that client device 102 to communicate and exchange data with the CDS system 102. The client application can provide a user interface (UI) for displaying patients' related content. The UI can include interactive objects (such as actionable items, icons, tabs, text input fields, or a combination thereof) to allow client device (or user) interaction. The client application can allow for patient selection, display of patient related content accessed from the CDS system 120, requesting clinical decision support information for a given patient, or a combination thereof.

FIG. 5A shows a patient list view 510 of the client application UI illustrating a patient list showing multiple patients and corresponding test results. The patient list view 510 can include the name, patient ID, photo and reason of hospital admission for each patient in the list. The patient list view 510 can also include medical test results 501 for each patient in the list. The patient list view 510 can emphasize abnormal test results 501b for each patient, for example, by displaying such results in highlighted mode or in different color or font than normal medical test results 501a. Such emphasis can attract the attention of a user of the client device. In some implementations, the patient list view 510 can allow the user to scroll up and down (or left and right) to see other patients data. The patient list view 510 can also allow the user to select (such as by clicking on a button or tapping the screen of the client device) a specific patient for more detailed patient information to be displayed. In some instances, the client application can be configured to display information for a given patient as an alert in the patient list view 510 upon analysis of that patient's clinical or medical information is complete.

FIG. 5B shows a patient profile view 520 for displaying profile information for a selected patient. Upon the user selecting a patient in the patient list view 510, a respective patient profile view 520 is displayed. The patient profile view 520 can show the patient test results, clinical terms indicative of corresponding abnormal test results, patient medications, patient allergies, patient demographic attributes and/or other patient medical information. In some implementations, the patient profile view can show a search query 525 generated by the analysis module 220 (and/or the search module 222) based on the information displayed in the patient profile view 520. In some implementations, the patient profile view 520 can allow the user of the client device to edit the displayed search query 525 and/or initiate the search using, for example, an actionable item 527.

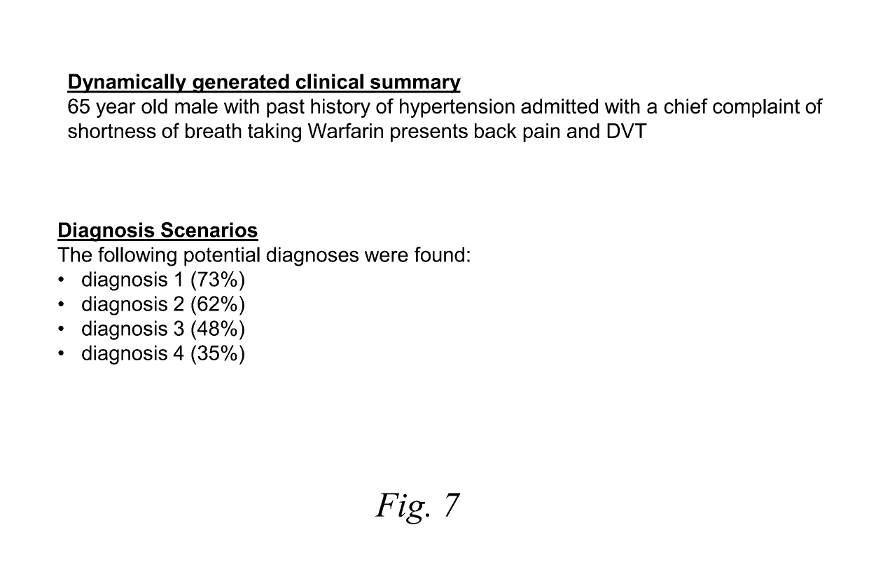

FIG. 5C shows a search results view 530 for displaying search results representing clinical decision support information. Upon the user initiating the search (such as through touching the screen of the client device, clicking a button, or actuating the actionable item 530), a list of search results can be displayed on the client device 102 as shown in FIG. 5 C. The search results list can include content items (e.g., articles) relevant to the patient medical conditions and the patient's medical history. The search results view can also show a diagnosis output (or diagnosis content item) as shown in FIG. 7.

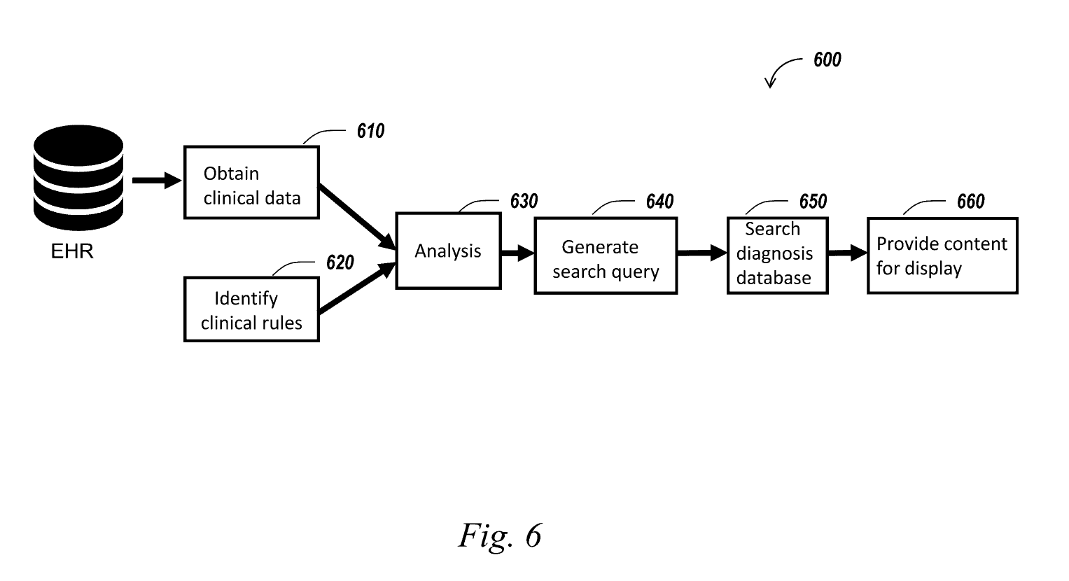

FIG. 6 is a flow diagram illustrating a second method 600 of providing clinical decision support. The method 600 is similar to the method 400 except that in method 600 the analysis of the patient medical data (at stage 630) is performed to generate a search query (stage 640) for searching potential diagnosis scenarios. The search query can include keywords indicative of patient expressed symptoms (such as indications of headache or pain, feeling of dizziness, etc.), test results or corresponding clinical terms, existing medical conditions or diseases, patient medications, patient demographic attributes or a combination thereof. The CDS system 120 can allow a user of a client device to edit the generated search query similar to method 400. The method 600 is also different from method 400 in that it includes searching a diagnosis database 215 using the generated dynamic search query to determine one or more potential diagnosis scenarios (stage 650).

The diagnosis database 215 can be a component of the CDS system 120 or an external database accessible by the CDS system 120 and/or the client devices. The diagnosis database can be include a list of diseases (or health conditions) and corresponding symptoms. In some implementations, the diagnosis database 215 can be configured to filter the maintained list based on the search query provided by the analysis module 220 to identify diseases or health conditions relevant to the patient. The diagnosis database 215 can provide the identified diseases or health conditions for display on a client device as a ranked list of diagnosis scenarios. The ranking of the diagnosis scenarios can be based on the relevance to the keywords in the search query, the likelihood of each diagnosis scenario.

FIG. 7 shows an example diagnosis output for display on a client device 102. The diagnosis output includes a dynamically generated clinical summary for the patient and a list of potential diagnosis scenarios. In some implementations, the list of potential diagnosis scenarios can include multiple ranked potential diagnoses and respective likelihoods. In some implementations, the list of potential diagnosis scenarios can include, for each potential diagnosis, respective indications of further medical test(s) or procedure(s) to rule out or confirm that diagnosis.

While the invention has been particularly shown and described with reference to specific embodiments, it should be understood by those skilled in the art that various changes in form and detail may be made therein without departing from the spirit and scope of the invention described in this disclosure.

While this specification contains many specific embodiment details, these should not be construed as limitations on the scope of any inventions or of what may be claimed, but rather as descriptions of features specific to particular embodiments of particular inventions. Certain features described in this specification in the context of separate embodiments can also be implemented in combination in a single embodiment. Conversely, various features described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated in a single software product or packaged into multiple software products.

References to “or” may be construed as inclusive so that any terms described using “or” may indicate any of a single, more than one, and all of the described terms.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain embodiments, multitasking and parallel processing may be advantageous.

What is claimed is:

1. A system for providing clinical decision support information, the system comprising:
a clinical rule database for storing a plurality of clinical rules, the plurality of clinical rules including at least one clinical rule mapping reference medical test values to one or more medical conditions;
an analysis module configured to:
receive, from an electronic health record (HER) database, clinical information associated with a patient, the clinical information including at least one medical test result;
identify one or more clinical rules from the plurality of clinical rules;
analyze the clinical information associated with the patient using the one or more clinical rules to identify one or more keywords indicative of one or more medical conditions of the patient;
send a request for clinical decision support information to a data source, the request including the one or more identified keywords;
receive, from the data source responsive to the request for clinical decision support information, one or more content items related to the one or more medical conditions of the patient; and
provide, via a communications network, the one or more content items for display on a client device.

2. The system of claim 1 further comprising a search module configured to generate a search query using the one or more identified keywords, the request for clinical decision support information including the search query.

3. The system of claim 1 further comprising a medical dictionary database configured to:
receive a medical acronym from the analysis module; and
provide, in response to the receiving medical acronym, a respective full-expression medical term for use by the analysis module to identify the one or more keywords.

4. The system of claim 1, wherein the analysis module is further configured to:
provide the one or more identified keywords to the client device for review; and
receive, from the client device, one or more revised keywords, the request for clinical decision support information including the one or more revised keywords.

5. The system of claim 1, wherein the data source includes a diagnosis database and wherein the one or more data items include a diagnosis content item indicative of one or more diagnosis results.

6. The system of claim 1 further comprising a client application executing on the client device, the client application configured to cause the client device to:
receive, from the analysis module, one or more clinical analysis results indicative of the one or more medical conditions of the patient; and
display, via a user interface (UI) of the client application, the analysis results.

7. The system of claim 6, wherein the analysis results include the at least one medical test result of the patient, and wherein displaying the analysis results include emphasizing abnormal medical test result values.

8. The system of claim 6, wherein the client application is further configured to:
provide an actionable item for display via the UI, the actionable item for initiating the request for the clinical decision support information;
cause the client device, upon actuation of the actionable item by a user of the client device, to send an indication of the actuation of the actionable item; and
cause the client device to display, via the UI of the client application, the one or more content items received from the analysis module.

9. The system of claim 8, wherein the client application is further configured to display the one or more identified keywords with the actionable item.

10. The system of claim 1, wherein identifying the one or more keywords includes:
comparing a medical test result in the clinical information associated with the patient to a respective reference medical test value range in a clinical rule of the one or more clinical rules; and
identify, based on the comparison, a medical term indicative of a medical condition mapped to the reference medical test value range as a keyword.

11. A method for providing clinical decision support information, the method comprising:
receiving, by a computer server from an electronic health record (HER) database, clinical information associated with a patient, the clinical information including at least one medical test result;
identifying, by the computer server, one or more clinical rules from a plurality of clinical rules stored in a database, the plurality of clinical rules including at least one clinical rule mapping reference medical test values to one or more medical conditions;
analyzing, by the computer server, the clinical information associated with the patient using the one or more clinical rules to identify one or more keywords indicative of one or more medical conditions of the patient;
sending, by the computer server, a request for clinical decision support information to a data source, the request including the one or more identified keywords;
receiving, by the computer server from the data source responsive to the request for clinical decision support information, one or more content items related to the one or more medical conditions of the patient; and
providing, by the computer server via a communications network, the one or more content items for display on a client device.

12. The method of claim 11 further comprising generating, by the computer server, a search query using the one or more identified keywords, the request for clinical decision support information including the search query.

13. The method of claim 11 further comprising:
identifying, by the computer server, a medical acronym within the clinical information associated with the patient or the one or more clinical rules; and
accessing, by the computer server, a medical dictionary database to determine a respective full-expression medical term corresponding to the medical acronym, the full-expression medical term used to identify the one or more keywords.

14. The method of claim 11 further comprising:
providing, by the computer server via a communications network, the one or more identified keywords to the client device for review; and
receiving, by the computer server from the client device, one or more revised keywords, the request for clinical decision support information including the one or more revised keywords.

15. The method of claim 11, wherein the data source includes a diagnosis database and the one or more data items include a diagnosis content item indicative of one or more diagnosis results.

16. The method of claim 11 further comprising:
providing, by the computer server to a client application executing on the client device, one or more clinical analysis results indicative of the one or more medical conditions of the patient; and
displaying, by the client application via a respective user interface (UI), the analysis results on the client device.

17. The method of claim 16, wherein the analysis results include the at least one medical test result of the patient, and wherein displaying the analysis results include emphasizing abnormal medical test result values.

18. The method of claim 16 further comprising:
providing, by the client application, an actionable item for display via the UI, the actionable item for initiating the request for the clinical decision support information;
sending, by the client device upon actuation of the actionable item, an indication of the actuation of the actionable item; and
displaying, by the client application via the respective UI, the one or more content items received from the analysis module.

19. The method of claim 11, wherein identifying the one or more keywords includes:
comparing a medical test result in the clinical information associated with the patient to a respective reference medical test value range in a clinical rule of the one or more clinical rules; and
identify, based on the comparison, a medical term indicative of a medical condition mapped to the reference medical test value range as a keyword.

20. A computer-readable medium including computer code instructions stored thereon, the computer code instructions when executed by a processor cause the processor to:
receive, from an electronic health record (HER) database, clinical information associated with a patient, the clinical information including at least one medical test result;
identify one or more clinical rules from a plurality of clinical rules stored in a database, the plurality of clinical rules including at least one clinical rule mapping reference medical test values to one or more medical conditions;
analyze the clinical information associated with the patient using the one or more clinical rules to identify one or more keywords indicative of one or more medical conditions of the patient;
send a request for clinical decision support information to a data source, the request including the one or more identified keywords;
receive, from the data source responsive to the request for clinical decision support information, one or more content items related to the one or more medical conditions of the patient; and
provide, via a communications network, the one or more content items for display on a client device.
